(19) United States
(12) Patent Application Publication
(10) Pub. No.: US 2019/0299374 A1
(43) Pub. Date: Oct. 3, 2019

(54) TOOLS FOR ATTACHING NUTS TO ELECTRICAL CABLES IN ELECTRICAL BOXES AND METHODS OF MAKING AND USING THE SAME

(71) Applicant: Sergio Fernandez, Pasadena, TX (US)

(72) Inventor: Sergio Fernandez, Pasadena, TX (US)

(21) Appl. No.: 16/365,589

(22) Filed: Mar. 26, 2019

Related U.S. Application Data
(60) Provisional application No. 62/649,635, filed on Mar. 29, 2018.

(51) Int. Cl. B25B 23/00; B25B 23/02; F16B 39/28

(52) U.S. Cl. CPC B25B 23/0057; F16B 39/28; B25B 23/02

(57) ABSTRACT

The present disclosure relates to hand-held tools for attaching or starting nuts onto threads of electrical cables in electrical boxes. In an embodiment, the tool or apparatus includes a driving stem that includes a first end and a second end, wherein the driving stem contains a first hollow recess; the first end including a first opening interface which connects to the first hollow recess; and a first plurality of prongs attached to the first opening interface, wherein the first plurality of prongs is configured to grasp and manipulate nuts.

### CROSS REFERENCE TO RELATED APPLICATION

This application claims the benefit of U.S. Provisional Patent Application Ser. No. 62/649,635, filed Mar. 29, 2018, the disclosure of which is incorporated herein by reference in its entirety.

### TECHNICAL FIELD

The present disclosure relates to hand-held tools for attaching or starting nuts onto threads of electrical cables in electrical boxes.

### BACKGROUND

As society's dependence on electricity to power lights, computers, tablets, smartphones, televisions and more grows, so does the need to install and maintain electrical outlets in buildings and vehicles. Many electrical outlets are formed by attaching electrical cables filled with wires to electrical junction boxes. These electrical junction boxes are typically recessed into the wall. The electrical junction boxes typically have walls with one or more cutouts where one or more electrical cables bearing threads and electrical wires can be inserted into the back or side of the box. Once the threads of the electrical cable have passed into the electrical junction box, then a type of nut, often known as a locknut, can be started onto the threads of the cable to attach the electrical cable to the electrical junction box.

Despite the need for tools to help electrical workers attach locknuts in electrical boxes, there are very few tools designed or adapted to help them do so. There is a need for a hand-held tool or apparatus that can start, tighten, or loosen locknuts onto electrical cables in recessed electrical junction boxes, especially for electrical junction boxes having narrow and/or deep dimensions.

### SUMMARY

The present disclosure relates to an apparatus or tool for starting or tightening nuts. In an embodiment, the apparatus includes a driving stem comprising a first end and a second end, wherein the driving stem contains a first hollow recess; the first end comprising a first opening interface which connects to the first hollow recess: and a first plurality of prongs attached to the first opening interface, wherein at least two of the first plurality of prongs have an inward facing surface a first distance from a first center of the first opening interface. In an embodiment of the apparatus, the first opening interface comprises a first inner lip and a first outer lip, and a longest span across the first opening interface of the first inner lip is from about 0.5 mm to 4 mm less than a longest span across the first opening interface of the first outer lip. In an embodiment of the apparatus, the first plurality of prongs is attached directly to the first outer lip. In an embodiment of the apparatus, the first plurality of prongs contains from 2 to 8 prongs. In an embodiment of the apparatus, the first plurality of prongs contains 3, 4, or 6 prongs; and the inward facing surface of the first plurality of prongs is substantially flat in a direction substantially perpendicular to the first opening interface. In an embodiment of the apparatus, the first distance is from about ⅛ inch to about ½ inch or from about 3 mm to about 15 mm. In an embodiment of the apparatus, the first distance is configured to fit a nut selected from the group consisting of a ¼ inch nut, a 5/16 inch nut, a ⅜ inch nut, a 7/16 inch nut, a ½ inch nut, a 9/16 inch nut, a ⅝ inch nut, a ¾ inch nut, a ⅞ inch nut, and a 1 inch nut; or the first distance is configured to fit a nut selected from the group consisting a 6 mm nut, a 7 mm nut, a 8 mm nut, a 10 mm nut, a 12 mm nut, a 14 mm nut, a 16 mm nut, a 18 mm nut, and a 20 mm nut. In an embodiment of the apparatus, the driving stem comprises at least one of a metal, a polymer, or a composite. In an embodiment of the apparatus, the driving stem comprises aluminum, chromium, copper, iron, lead, magnesium, nickel, silver, tin, titanium, zinc, or an alloy or carbide thereof; or comprises an acrylonitrile butadiene styrene, a nylon 6, a nylon 6-6, a polyamide, a polybutylene terephthalate, a polycarbonate, a polyetheretherketone, a polyetherketone, a polyethylene terephthalate, a polyimide, a polyoxymethylene plastic, a polyphenylene sulfide, a polyphenylene oxide, a polysulphone, a polytetrafluoroethylene, or a copolymer or blend thereof.

In an embodiment of the apparatus, the driving stem includes a non-conductive material on an outer surface of the driving stem between the first end and the second end, or wherein at least one of the driving stem, the first opening interface, the first plurality of prongs, the second opening interface, and the second plurality of prongs is at least partially magnetic. In an embodiment of the apparatus, the non-conductive material comprises a rubber, a polymer, a non-conductive metal, or a wood containing material. In an embodiment of the apparatus, a distance between the first end and the second end is from about 2 cm to about 30 cm. In an embodiment of the apparatus, a length of the first plurality of prongs in a direction substantially perpendicular to the first opening interface is from 1 mm to about 8 mm. In an embodiment of the apparatus, the second end includes a second opening interface which connects to a second hollow recess; and a second plurality of prongs is attached to the second opening interface, wherein at least two of the second plurality of prongs have an inward facing surface a second distance from a second center of the second opening interface. In an embodiment of the apparatus, the second opening interface comprises a second inner lip and a second outer lip, and wherein a longest span across the second opening interface of the second inner lip is from about 0.5 mm to 4 mm less than a longest span across the second opening interface of the second outer lip. In an embodiment of the apparatus, the second plurality of prongs is attached directly to the second outer lip. In an embodiment of the apparatus, the second distance is from about ⅛ inch to about ½ inch or from about 3 mm to about 15 mm; wherein the second distance is configured to fit a nut selected from the group consisting of a ¼ inch nut, a 5/16 inch nut, a ⅜ inch nut, a 7/16 inch nut, a ½ inch nut, a 9/16 inch nut, a ⅝ inch nut, a ¾ inch nut, a ⅞ inch nut, and a 1 inch nut; or wherein the second distance is configured to fit a nut selected from the group consisting a 6 mm nut, a 7 mm nut, a 8 mm nut, a 10 mm nut, a 12 mm nut, a 14 mm nut, a 16 mm nut, a 18 mm nut, and a 20 mm nut; and wherein the first distance and the second distance are the same or different. In an embodiment of the apparatus, the first hollow recess and the second hollow recess are connected or unconnected. In an embodiment of the apparatus, the second opening interface has a shape configured to engage a ratchet, a wrench, or a handle. In an embodiment of the apparatus, at least one of the first opening interface and the second opening interface is attached to the driving stem by a hinge, or at least one of the first opening interface and the second opening interface is directly attached to the driving stem.

### BRIEF DESCRIPTION OF THE DRAWINGS

The foregoing summary, as well as the following detailed description of the embodiments, will be better understood when read in conjunction with the attached drawings. For the purpose of illustration, there are shown in the drawings some embodiments, which may be preferable. It should be understood that the embodiments depicted are not limited to the precise details shown, and are not drawn to scale.

FIG. 1 is a schematic of an embodiment of the apparatus, where the first and second opening interfaces are in a closed position.

FIG. 2 is a schematic of an embodiment of the apparatus, depicted from a perspective of looking along a lengthwise axis at a first opening interface that is in a closed position.

FIG. 3 is a schematic of an embodiment of the apparatus, where the first and second opening interfaces are in an open position.

FIG. 4 is a schematic of an embodiment of the apparatus from a perspective of looking along a lengthwise axis at a second opening interface that is in a closed position.

FIG. 5 is a schematic of an embodiment of the apparatus for starting nuts, where both the first and second opening interfaces are in a closed position, and a side view of the apparatus is shown.

FIG. 6 is a schematic of depiction of an embodiment of the apparatus relative to an electrical junction box, where a nut has just been tightened to attach an electrical cable to the back of the electrical junction box.

FIG. 7 is a prototype of an embodiment of the apparatus.

FIG. 8 is a different view of the same prototype of an embodiment of the apparatus shown in FIG. 7.

FIG. 9 is a prototype of an embodiment of the apparatus, shown from a side view.

FIG. 10 is a different view of the same prototype of an embodiment of the apparatus shown in FIG. 9, shown from an off axis perspective.

FIG. 11 is a prototype of an embodiment of the apparatus, shown from an off axis perspective and holding a lock nut among four prongs.

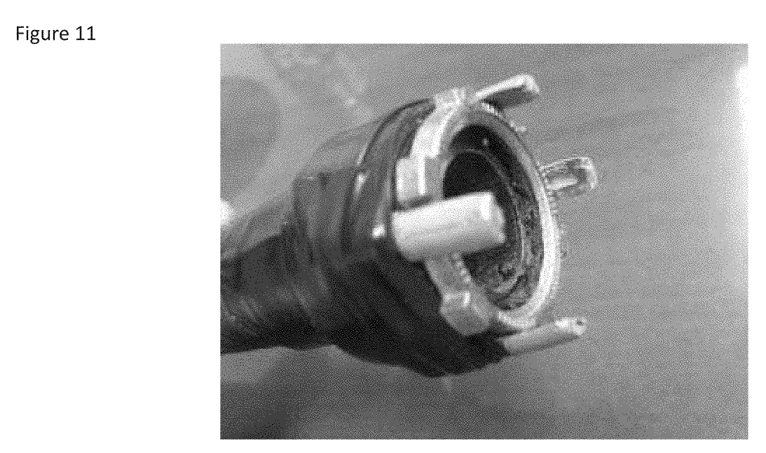

FIG. 12 is a prototype of an embodiment of the apparatus, shown from a side view, holding a lock nut among four prongs, and depicted just before starting a locknut onto the threads of an electrical cable with the wires of the electrical cable extending into a first hollow recess of the apparatus.

FIG. 13 is schematic of an embodiment of the apparatus from a side view (A), a view down the axis of the first end (B), and an off axis view of the second end (C). The schematic of the embodiment of the apparatus in FIGS. 13A-C each have 3 prongs and the second end is configured to functionally engage a ratchet.

FIG. 14 is a schematic of the embodiment of the apparatus of FIG. 13, wherein the second end of the apparatus is depicted as functionally engaging a ratchet (A), and the first end of the apparatus is suggestively depicted as nearly engaging a locknut in the confines of an electrical junction box (B).

FIG. 15A shows a picture of different sized prototypes of an embodiment of the apparatus, wherein each size of prototype is configured to fit the locknut shown below the prototype. FIG. 15B shows a picture of a prototype of an embodiment of the apparatus, wherein the second end of the prototype is functionally engaging or fits to a commercially available ratchet. FIG. 15C shows a picture of the prototype and ratchet from FIG. 15B engaging a locknut in the confines of an electrical junction box.

FIG. 16 is a schematic depiction of the apparatus shown from a side view (A), an off-axis view from the second end (B), and a depiction of the apparatus relative to an electrical junction box in a manner that suggests how the apparatus might engage the locknut therein (C). FIG. 16D is photo of a prototype of the embodiments shown in FIGS. 16A-C.

### DETAILED DESCRIPTION

Unless otherwise noted, all measurements are in standard metric units.

Unless otherwise noted, all instances of the words “a,” “an,” or “the” can refer to one or more than one of the word that they modify.

Unless otherwise noted, the phrase “at least one of” means one or more than one of an object. For example, “at least one of a metal, a polymer, or a composite” means a metal, a polymer, a composite, or a combination thereof.

Unless otherwise noted, the term “about” refers to ±5% of the non-percentage number that is described. For example, about 100 mm, would include up to 95 to 115 mm. Unless otherwise noted, the term “about” refers to ±5% of a percentage number. For example, about 20% would include up to 15 to 25%. When the term “about” is discussed in terms of a range, then the term refers to the appropriate amount less than the lower limit and more than the upper limit. For example, from about 100 to about 200 mm would include from up to 95 to 210 mm.

Unless otherwise noted, the term “apparatus” and “tool” are used interchangeably.

Unless otherwise noted, the term “substantially” in the context of a direction, orientation, or shape means within up to and including 10 degrees. For example, “substantially perpendicular” would mean perpendicular within 10 degrees. “Substantially flat” would mean flat within 10 degrees.

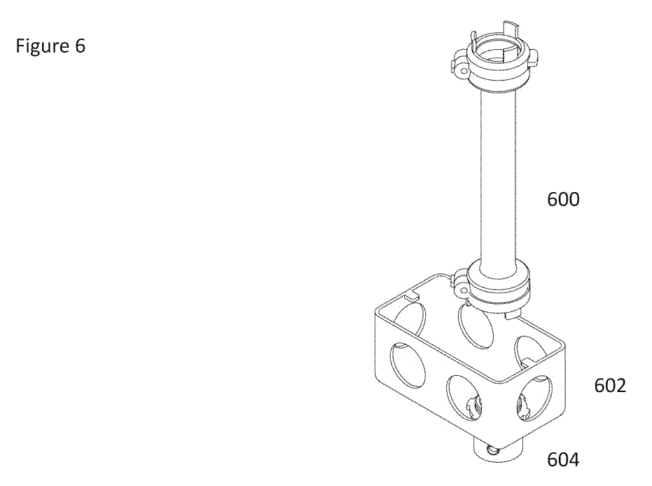

The present disclosure relates to an apparatus for attaching nuts, including starting, tightening, or loosening nuts. The attachment of electrical cables using nuts, such as locknuts, into electrical junction boxes presents a challenging set of unique problems. For example, a worker such as an electrician, mechanic, or communications expert may have to install dozens of electrical junction boxes into a building under construction per day or per hour. Referring to FIG. 6, electrical junction boxes (602) often present a narrow recessed space that severely limits the ability of the worker to use their hands or tools to start and tighten a locknut onto the threads of the electrical cable. For example, the electrical junction box may be several inches or centimeters deep but only a few inches or centimeters wide and tall. Further, an electrical cable may be attached to the electrical junction box from the back of the box, the side of the box, or at even more awkward angles, which requires that the locknut be tightened directly against the back of the box, the side of the box, or at even more awkward angle. Also, the electrical cable being attached to the electrical junction box may be one of several being attached to that junction box, which further limits the movement and accessibility of the locknut being tightened onto the electrical cable because the locknut would be tightened within a few millimeters of the locknut and electrical cable that is already attached. Also, the electrical cable being attached almost always has wires protruding from the end of the electrical cable and at the center of the threads of the electrical cable because it is these wires which will be attached to the a future outlet. Therefore, the tool being used to start the locknut onto the threads of the electrical cable should be able to safely start, tighten, or loosen the locknut with around from 5 or more centimeters of wires protruding from the threaded opening of the electrical cable. Furthermore, the locknut may need to be tightened past all of the lose wiring that is already present in the electrical junction box, which further limits movement of hands and tools in the electrical junction box and increases the possibility of the locknut be accidently brushed off of any tool being used. Also, the apparatus tightening the locknut should be able to safely insulate the worker from accidental electrical discharges, because sometimes static discharges buildup in the electrical wires and other times one or more of the electrical wires may be accidently carrying a current.

Another set of problems is based on the context of the worker attaching the electrical cable to the electrical junction box. For example, because electrical instillation typically occurs during the construction of a building, the worker must find a way to attach the nut to the electrical cable under conditions that include poor lighting, excessive heat, excessive cold, wet surfaces, and awkward positioning, such as laying on the floor or standing with one hand on a ladder 30 feet off the ground. Similarly, a mechanic attaching or removing a nut from an electrical junction box of an airplane may work in rain, wind, poor lighting, and while standing on a ladder. Therefore, the tool should be able to be operated by one hand at a variety of angles. Further, the tool should be able to hold the nut before and during starting the nut onto the threads of the electrical cable. Furthermore, the tool should be able to grasp the nut before and during loosening or removing the nut off of the threads of the electrical cable. The tool should be lightweight so it can be easily carried up a ladder and not have multiple parts, as in a ratchet kit or an Allen wrench set. The tool should also avoid requiring both hands and other tools to operate.

The apparatus of the present disclosure seeks to address as many of these issues as possible, because many workers have given up on finding a tool that can deal with all of these problems. It is common for workers to use their fingers to start the nut onto the electrical threads of the electrical cable, which is awkward and potentially dangerous. Further, to tighten the nut, many workers have resorted to using a flathead screw driver and hammer to “chisel tighten” the nut. This method of tightening the nut increases the possibility of stripping the nut and damaging the surrounding electrical wires, which can interfere with electrical performance and increase the risk accidental electrocution.

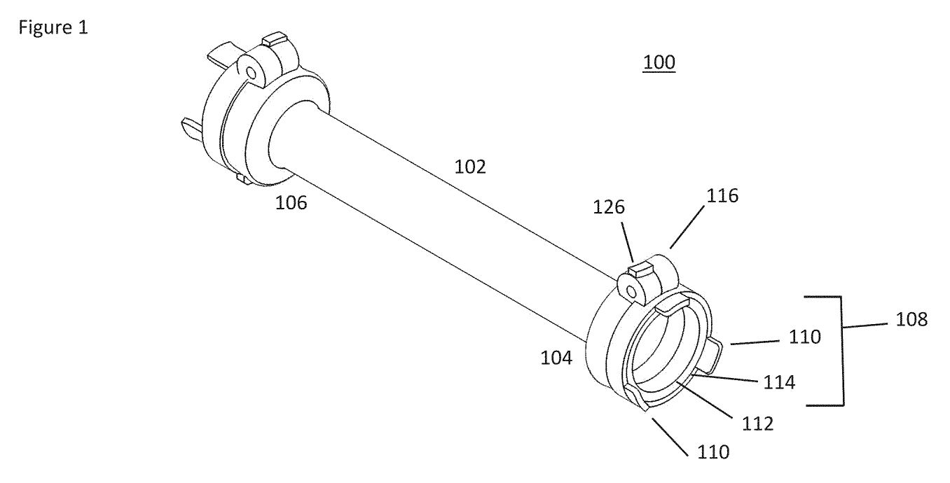

The present disclosure relates to an apparatus or tool for starting and/or tightening nuts onto electrical threads. Referring to FIGS. 1, 2, 3, 4, and 13 in an embodiment, the apparatus (100, 200, 300, 400, 700, 800, 900) includes a driving stem (102, 302, 702, 902) that includes a first end (104, 204, 304, 704, 904) and a second end (106, 306, 406, 706, 906), wherein the driving stem contains a first hollow recess; the first end includes a first opening interface (108, 208, 308, 708, 808) which connects to the first hollow recess; and a first plurality of prongs (110, 210, 310, 710, 810) attached to the first opening interface, wherein at least two of the first plurality of prongs have an inward facing surface (218, 818) a first distance (222, 822) from a first center of the first opening interface.

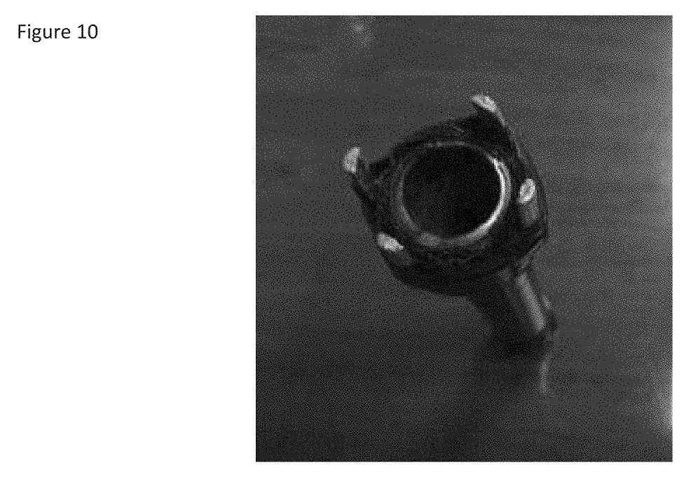

Referring to FIGS. 1, 2, 3, and 13 in an embodiment, the apparatus includes a first opening interface (208, 708, 808). In an embodiment, the opening interface includes a first plurality of prongs (210, 710, 810), a first inner lip (112, 212, 312, 812), and a first outer lip (114, 214, 314, 814). In an embodiment, at least one of the first plurality of prongs has an inner surface (218, 818) and an outer surface (220, 820), wherein the inner surface faces the center of the first opening interface. In an embodiment, a longest span across the first opening interface of the first inner lip is from about 0.5 mm to about 4 mm less than a longest span across the first opening interface of the first outer lip, including from about 1 mm to about 3 mm. In an embodiment, the first opening interface is configured such that a nut can sit against the inner lip and/or outer lip of the opening interface while the nut is held between at least two inner surfaces of the first plurality of prongs. For example, FIG. 10 shows an embodiment of the apparatus with a nut sitting against the inner lip and/or outer lip and held between four prongs of a first opening interface. In an embodiment, the first opening interface can be a structure with an inner or outer surface shaped like an open or closed ring having a circular or elliptical shape. In an embodiment, the first opening interface can have an open or closed ring shaped like a triangle, rectangle, square, pentagon, hexagon, heptagon, or higher polygon that may form a continuous or discontinuous ring. In an embodiment, the first opening interface has an axis that is perpendicular or substantially perpendicular to the opening of the opening interface and passes though the center of the inner outer lip.

In an embodiment, the first plurality of prongs is attached directly or indirectly to the first outer lip. In an embodiment, the first plurality of prongs is made of the same or substantially the same material as the first outer lip of the first opening interface and/or the driving stem. In an embodiment the first plurality of prongs contains from 2 to 8 prongs, including 2, 3, 4, 5, 6, 7, or 8 prongs.

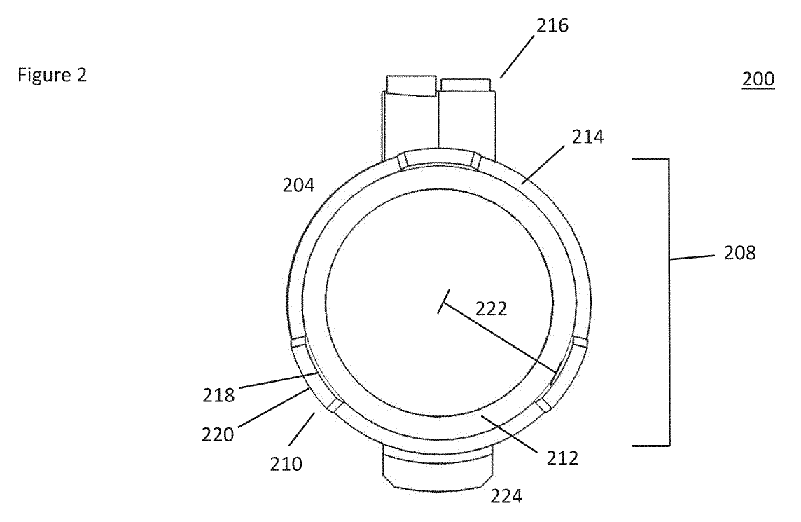

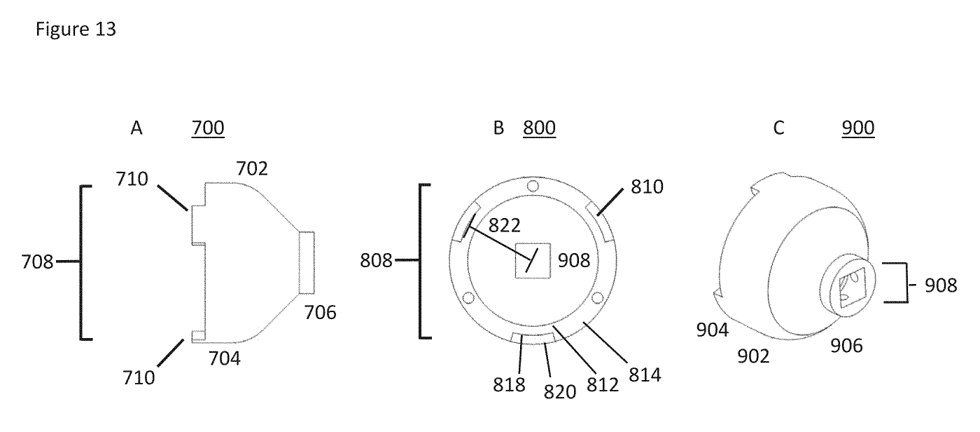

In an embodiment, the inward facing surface of the first plurality of prongs is substantially flat in a direction substantially perpendicular to the first opening interface. In an embodiment, referring to FIGS. 2 and 13B, a prong (210, 810) is a first distance (222, 822) from the center or axis of the first opening interface. The first distance is not generally limited, so long as it allows for a nut to be held, manipulated, and released from the first plurality of prongs. In an embodiment, the first distance is from about ⅛ inch to about ½ inch or from about 3 mm to about 15 mm. In an embodiment, the first distance of one or more of the first plurality of prongs is the same or different. In an embodiment, the first distance can be measured as half the distance from the inner surface of a prong across the longest span across the first opening interface. In an embodiment, the first distance is configured to fit a nut selected from the group consisting of a ¼ inch nut, a 5/16 inch nut, a ⅜ inch nut, a 7/16 inch nut, a ½ inch nut, a 9/16 inch nut, a ⅝ inch nut, a ¾ inch nut, a ⅞ inch nut, and a 1 inch nut; or the first distance is configured to fit a nut selected from the group consisting a 6 mm nut, a 7 mm nut, a 8 mm nut, a 10 mm nut, a 12 mm nut, a 14 mm nut, a 16 mm nut, a 18 mm nut, and a 20 mm nut. In an embodiment, a length of the first plurality of prongs in a direction substantially perpendicular to the first opening interface is from 1 mm to about 8 mm, including from 1 mm to about 5 mm, including from 2 to 4 mm, as measured from the first outer lip to the tip of a prong. In an embodiment, the first plurality of prongs is resilient.

One benefit of the first plurality of prongs can be that the prongs grip a nut before starting the nut onto the threads of the electrical cable. This benefit can allow for a worker to manipulate the nut using the apparatus at awkward positions, at extreme angles, under adverse conditions, and past multiple wires in the tight confines of an electrical junction box. Further another benefit of the first plurality of prongs can be that as the nut is started and/or tightened onto the threads of the electrical cable, the ends of the prongs make contact with the surface of the electrical junction box. This contact and continued tightening of the nut can cause the prongs to splay out or spread out enough to release the nut from the grasp of the first plurality of prongs. Conversely, a benefit to the first plurality of prongs can be that when a nut is being loosened, the first plurality of prongs begins in the splayed or spread position and slowly grips the nut as the nut is removed from the threads of the electrical cable.

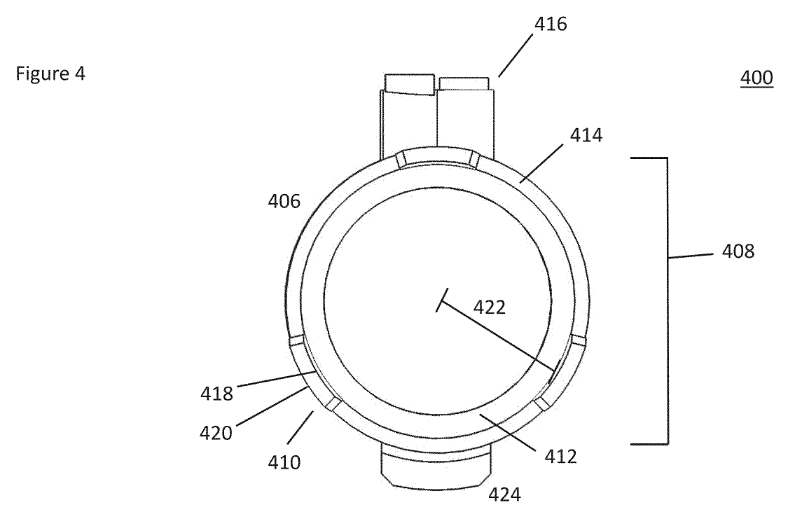

Referring to FIG. 4 and FIG. 13, in an embodiment, the apparatus includes a second opening interface (408, 908). In an embodiment, the opening interface includes a second plurality of prongs (410), a second inner lip (412), and a second outer lip (414). In an embodiment, at least one of the second plurality of prongs has an inner surface (418) and an outer surface (420), wherein the inner surface faces the center of the second opening interface. In an embodiment, a longest span across the second opening interface of the second inner lip is from about 0.5 mm to 4 mm less than a longest span across the second opening interface of the second outer lip, including from about 1 mm to 3 mm. In an embodiment, the second opening interface is configured such that a nut can sit against the inner lip of the opening interface while the nut is held between at least two inner surfaces of the second plurality of prongs.

In an embodiment, the second plurality of prongs is attached directly or indirectly to the second outer lip. In an embodiment, the second plurality of prongs is made of the same and/or substantially the same material as the second outer lip of the second opening interface or the driving stem. In an embodiment the second plurality of prongs contains from 2 to 8 prongs, including 2, 3, 4, 5, 6, 7, or 8 prongs.

In an embodiment, the inward facing surface of the second plurality of prongs is substantially flat in a direction substantially perpendicular to the second opening interface.

In an embodiment, a prong (410) is a second distance (422) from the center or axis of the second opening interface. The second distance is not generally limited, so long as it allow for a nut to be held, manipulated, and released from the second plurality of prongs. In an embodiment, the second distance is from about ⅛ inch to about ½ inch or from about 3 mm to about 15 mm. In an embodiment, the second distance of one or more of the second plurality of prongs is the same or different. In an embodiment, the second distance can be measured as half the distance from the inner surface of a prong across the longest span across the second opening interface. In an embodiment, the second distance is configured to fit a nut selected from the group consisting of a ¼ inch nut, a 5/16 inch nut, a ⅜ inch nut, a 7/16 inch nut, a ½ inch nut, a 9/16 inch nut, a ⅝ inch nut, a ¾ inch nut, a ⅞ inch nut, and a 1 inch nut; or the second distance is configured to fit a nut selected from the group consisting a 6 mm nut, a 7 mm nut, a 8 mm nut, a 10 mm nut, a 12 mm nut, a 14 mm nut, a 16 mm nut, a 18 mm nut, and a 20 mm nut. In an embodiment, a length of the second plurality of prongs in a direction substantially perpendicular to the second opening interface is from 1 mm to about 8 mm, including from 1 mm to about 5 mm, including from 2 to 4 mm, as measured from the second outer lip to the end of a prong. In an embodiment, the second plurality of prongs are resilient.

One benefit of the second plurality of prongs can be that the prongs grip a nut before starting the nut onto the threads of the electrical cable. This benefit can allow for a worker to manipulate the nut in the apparatus at awkward positions, at extreme angles, under adverse conditions, and past multiple wires in the tight confines of an electrical junction box. Further another benefit of the second plurality of prongs can be that as the nut is started and/or tightened onto the threads of the electrical cable, the ends of the prongs make contact with the surface of the electrical junction box. This contact and continued tightening of the nut can cause the prongs to splay out or spread out enough to release the nut from the grasp of the second plurality of prongs. Conversely, a benefit to the second plurality of prongs can be that when a nut is being loosened, the second plurality of prongs begins in the splayed position and slowly grips the nut as the nut is removed from the threads of the electrical cable. One benefit of the second plurality of prongs can be that the prongs are thin enough to manipulate a nut located less 2 or 3 millimeters from an adjacent nut.

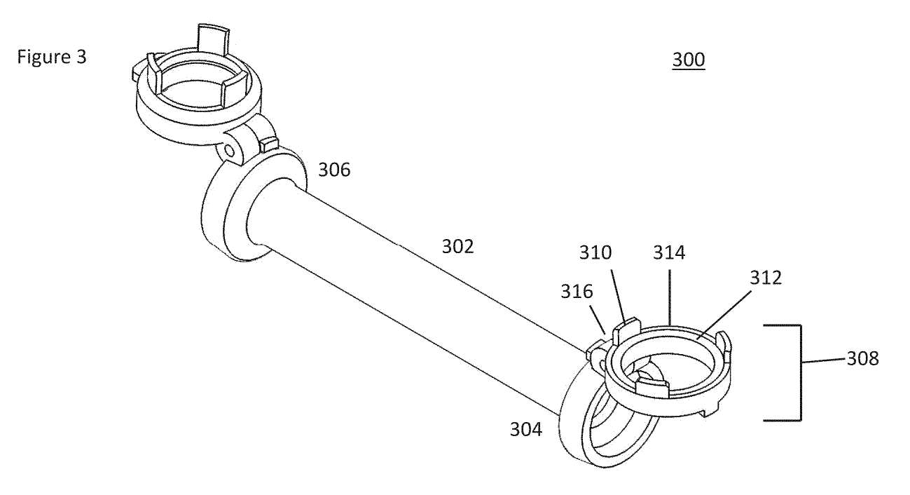

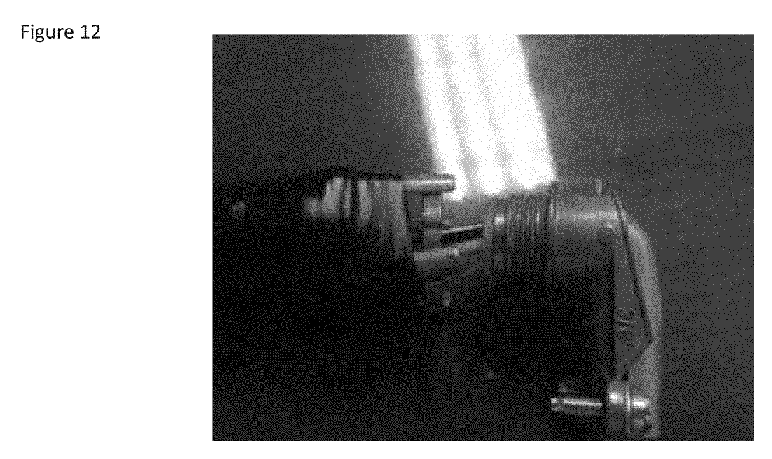

In an embodiment of the apparatus, referring to FIGS. 1 and 3, the apparatus includes a driving stem (102, 302). In an embodiment, the driving stem has one, two, three, or four ends, including a first end and optionally a second end. In an embodiment, an end has a hollow recess that can connect to an opening interface. In an embodiment, the first hollow recess and the second hollow recess are connected or unconnected. In an embodiment, the hollow recess of one end of the driving stem can connect to the hollow recess of another end, such that the driving stem or apparatus is predominately hollow. The width or span of the hollow recess is not generally limited so long as the hollow recess is wide enough to allow for wires to be passed inside of it, if needed, and narrow enough to allow for a comfortable hand grip on the outside of the driving stem. In an embodiment, the width of the hollow recess ranges from ⅛ inch to about 1 inch or from about 3 mm to about 30 mm. In an embodiment, the depth of a hollow recess ranges from about 3 to about 8 inches or more, as the hollow recess may extend out the other side of the apparatus. A benefit of a driving stem having a hollow recess that connects to an opening interface can be that the wires of an electrical cable can pass into the hollow recess of the driving stem while the nut is being started, tightened, or loosened onto or from the electrical cable as shown in FIG. 12. Another benefit of a hollow recess, or more than one hollow recess should be a reduction in the weight of the apparatus.

Similarly, the length of the driving stem is not generally limited so long as it allows for wires to pass into the hollow recess of the driving stem and allows for a hand grip. In an embodiment, the length of the driving stem includes from about 2 cm to about 30 cm, including from about 10 cm to about 20 cm.

The materials used to construct the apparatus, driving stem, opening interface, and/or prongs are not generally limited so long as they are strong enough and durable enough to start, tighten, or loosen a nut onto threads. Suitable materials for the driving stem include a metal, a polymer, or a composite or a combination thereof. Suitable materials for the apparatus, driving stem, opening interface, and/or prongs include aluminum, chromium, copper, iron, lead, magnesium, nickel, silver, tin, titanium, zinc, or an alloy or carbide thereof or comprises an acrylonitrile butadiene styrene, a nylon 6, a nylon 6-6, a polyamide, a polybutylene terephthalate, a polycarbonate, a polyetheretherketone, a polyetherketone, a polyethylene terephthalate, a polyimide, a polyoxymethylene plastic, a polyphenylene sulfide, a polyphenylene oxide, a polysulphone, a polytetrafluoroethylene, or a copolymer or blend thereof. In an embodiment, the apparatus, driving stem, opening interface, and/or prongs is magnetic or capable of being magnetized. One benefit to having magnetic prongs is that the force of the magnetic pull between the magnetic prongs and the nut can help keep the nut in place during manipulation, especially one-handed manipulation, of the apparatus and nut.

In an embodiment, the driving stem includes a non-conductive material on an outer surface of the driving stem between the first end and the second end. One benefit to having a non-conductive material on an outer surface of the driving stem can be to insulate a worker from accidental shock or to provide a more comfortable grip during manipulation of the apparatus.

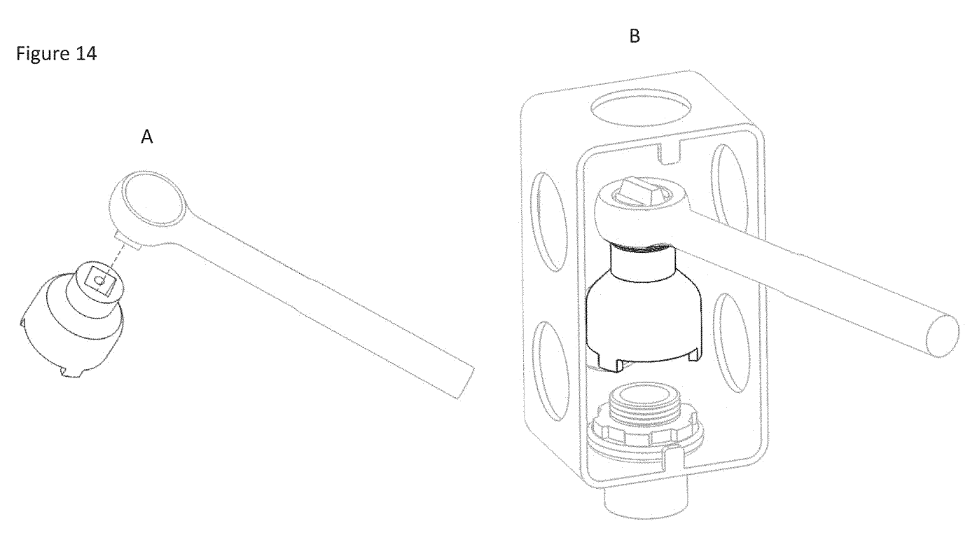

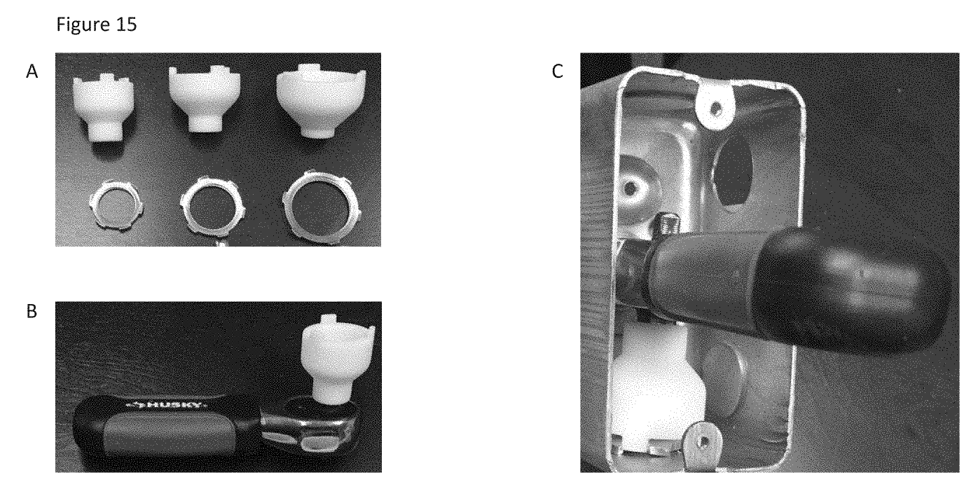

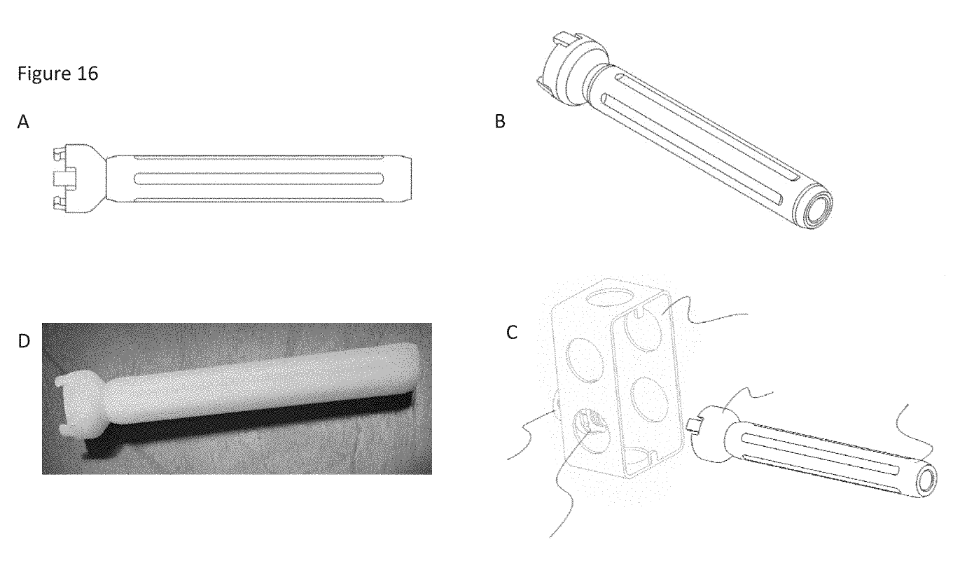

In an embodiment, the apparatus has a first end and a second end, wherein the first distance and the second distance are different, such that each end is configured to manipulate a different size nut. One benefit of an embodiment of the apparatus having two ends configured to manipulate different size nuts can be that the apparatus can manipulate nuts of two different sizes without having to switch to another wrench, as in a set of wrenches, and without having to switch to a separate interface piece, as in a ratchet set. FIGS. 13, 14, and 15 show an embodiment of the apparatus configured to interface or functionally engage or fit a ratchet. In an embodiment, the apparatus is a single continuous tool that does not include removable parts or is configured to exclude removable parts. FIG. 16 shows an embodiment of the apparatus that is a single continuous tool and excludes removable parts.

In an embodiment, the second end has a shape configured to engage a ratchet, a wrench, or a handle. One benefit of an embodiment with a second end configured to engage a ratchet, a wrench, or a handle is that the second end can be manipulated outside of the confines of the electrical junction box while threading, tightening, or loosening a nut inside the electrical junction box.

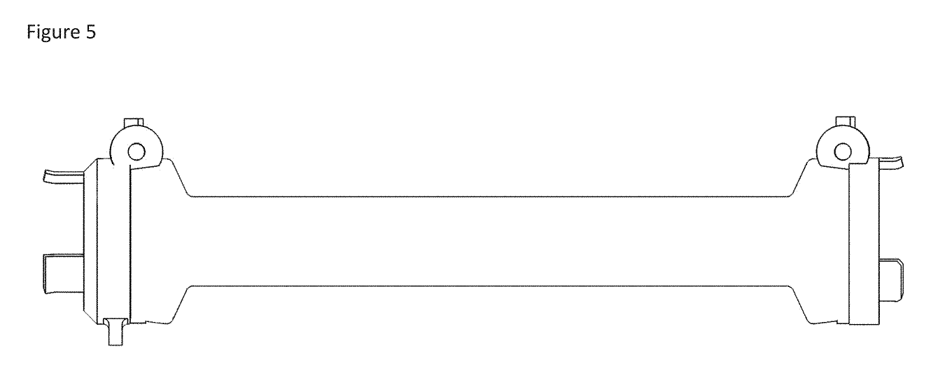

In an embodiment, at least one of the first opening interface and the second opening interface is attached to the driving stem by a hinge (116, 216, 316, 416), or at least one of the first opening interface and the second opening interface is directly attached to the driving stem. In an embodiment of the apparatus (600), the first opening interface and/or the second opening interface is attached to the driving stem by a hinge, including an adjustable hinge. One benefit of having a first opening interface and/or a second opening interface attached to the driving stem by a hinge is that the opening interface can be adjusted to manipulate nuts at various angles. For example, referring to FIG. 6, many electrical junction boxes (602) have openings in the back of the box and in the sides of the box. There are a few tools designed to start, tighten, or loosen nuts against the side of an electrical junction box, but there do not appear to be any tools designed to tighten nuts onto electrical cables (604) attached from the back of the electrical junction box or at other such difficult angles. This lack of a proper tool can be especially problematic when the point of attachment is recessed several inches or centimeters into the electrical junction box. One benefit of the hinge can be that the opening interface can be adjusted to manipulate nuts at various angles while the hinge still allows for the apparatus to apply torque and pressure toward or against the threads of an electrical cable or a bolt. The type of hinge used is not generally limited so long as the hinge allows for the apparatus to apply torque at various angles. Referring to FIGS. 1 and 5, when a hinges is present, then the “closed” position is where the axis of an opening interface coincides or is substantially parallel to the lengthwise axis of the driving stem. Referring to FIG. 3, in contrast, when a hinge is present, then an “open” position is where an opening interface is adjusted such that the center axis of the opening interface does not coincide or is not substantially parallel to the lengthwise axis of the driving stem. Unless otherwise noted, the center axis of an opening interface is understood to be centered and perpendicular to the opening of the opening interface. Referring to FIG. 1, in an embodiment of the apparatus, when a hinge is present, then the hinge may include a stop guard (126) that limits the range of motion of the hinge. A benefit to a stop guard is that it limits the movement of an opening interface beyond specific angles, which can allow for torque to be applied during use. Referring to FIGS. 2 and 4, in an embodiment of the apparatus, when a hinge is present, then a handle (224, 424) may be located or attached to an opening interface to make it easier to adjust the angle of the opening interface relative to the driving stem.

In an embodiment, the first opening interface and/or the second opening interface is directly attached to the driving stem. One benefit of this embodiment can be that the cost of production can be lowered as the apparatus can be made from a single material and/or a single manufacturing process. Another benefit of this embodiment can be that the apparatus is configured to manipulate nuts that are being tightened or loosened against the back of the recessed electrical junction box, because the need for tools to address this angle appears to be significant and does not appear to be addressed by any other tool.

It should be apparent that the apparatus disclosed herein is not limited to use in electrical junction boxes or electrical boxes, or limited to attaching locknuts. The apparatus should be able to attach nearly any nut and to function in most environments where a nut needs to be attached to threading. The electrical junction box and locknut combination was merely the inspiration for the apparatus disclosed herein.

A method of making an apparatus or tool for starting, tightening, or loosening nuts is disclosed. In an embodiment of the method, an embodiment of the apparatus can be made using conventional tool manufacturing techniques, including casting, sintering, injection molding, 3-D printing, Direct Metal Laser Sintering (DMLS), and/or machining a suitable material. For example, an embodiment of the apparatus can be manufactured by casting molten stainless steel into a permanent stainless steel or aluminum cast. Also, an embodiment of the apparatus can be manufactured by sintering a metal power, such as an iron alloy, in a stainless steel or aluminum cast.

### Examples

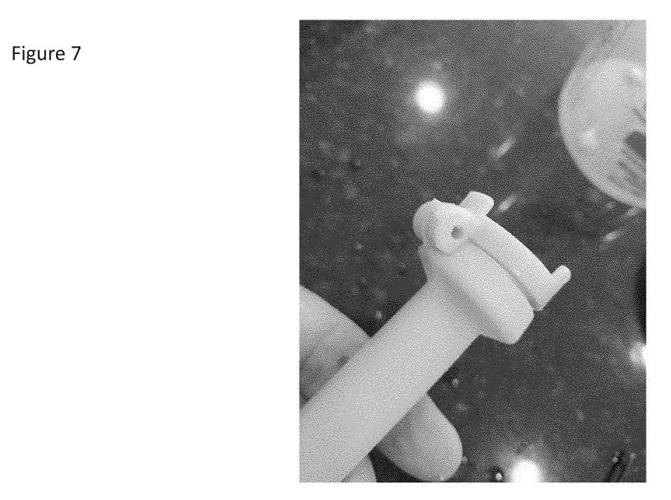

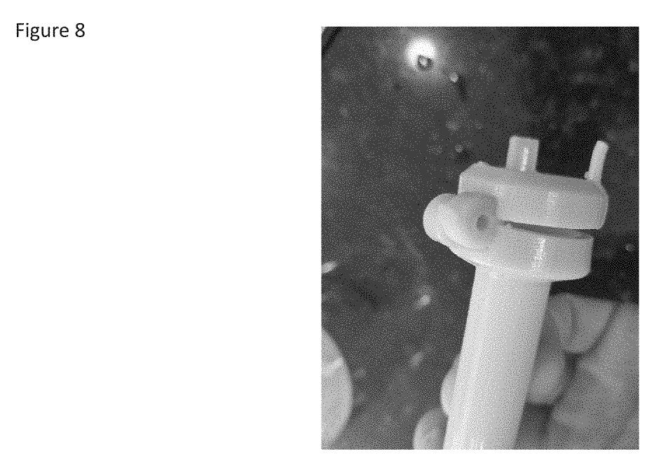

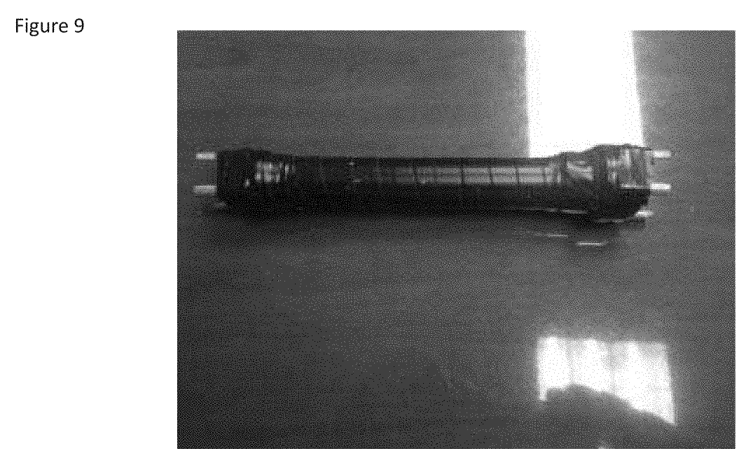

Referring to FIGS. 7, 8, 15A-C, and 16D embodiments of the apparatus were made by injection molding polyurethane. Referring to FIG. 9 and FIG. 10, an embodiment of the apparatus was made by attaching steel prongs to a pipe using electrical tape.

What is claimed is:

1. An apparatus comprising:
a driving stem comprising a first end and a second end, wherein the driving stem contains a first hollow recess;
the first end comprising a first opening interface which connects to the first hollow recess: and
a first plurality of prongs attached to the first opening interface, wherein at least two of the first plurality of prongs have an inward facing surface a first distance from a first center of the first opening interface.

2. The apparatus of claim 1, wherein the first opening interface comprises a first inner lip and a first outer lip, and
a longest span across the first opening interface of the first inner lip is from about 0.5 mm to 4 mm less than a longest span across the first opening interface of the first outer lip.

3. The apparatus of claim 2, wherein the first plurality of prongs is attached directly to the first outer lip.

4. The apparatus of claim 1, wherein the first plurality of prongs contains from 2 to 8 prongs.

5. The apparatus of claim 1, wherein the first plurality of prongs contains 3, 4, or 6 prongs; and
wherein the inward facing surface of the first plurality of prongs is substantially flat in a direction substantially perpendicular to the first opening interface.

6. The apparatus of claim 1, wherein the first distance is from about ⅛ inch to about ½ inch or from about 3 mm to about 15 mm.

7. The apparatus of claim 1, wherein the first distance is configured to fit a nut selected from the group consisting of a ¼ inch nut, a 5/16 inch nut, a ⅜ inch nut, a 7/16 inch nut, a ½ inch nut, a 9/16 inch nut, a ⅝ inch nut, a ¾ inch nut, a ⅞ inch nut, and a 1 inch nut; or
the first distance is configured to fit a nut selected from the group consisting a 6 mm nut, a 7 mm nut, a 8 mm nut, a 10 mm nut, a 12 mm nut, a 14 mm nut, a 16 mm nut, a 18 mm nut, and a 20 mm nut.

8. The apparatus of claim 1, wherein the driving stem comprises at least one of a metal, a polymer, or a composite.

9. The apparatus of claim 1, wherein the driving stem comprises aluminum, chromium, copper, iron, lead, magnesium, nickel, silver, tin, titanium, zinc, or an alloy or carbide thereof; or
comprises an acrylonitrile butadiene styrene, a nylon 6, a nylon 6-6, a polyamide, a polybutylene terephthalate, a polycarbonate, a polyetheretherketone, a polyetherketone, a polyethylene terephthalate, a polyimide, a polyoxymethylene plastic, a polyphenylene sulfide, a polyphenylene oxide, a polysulphone, a polytetrafluoroethylene, or a copolymer or blend thereof.

10. The apparatus of claim 1, wherein the driving stem includes a non-conductive material on an outer surface of the driving stem between the first end and the second end, or
wherein at least one of the driving stem, the first opening interface, the first plurality of prongs, the second opening interface, and the second plurality of prongs is at least partially magnetic.

11. The apparatus of claim 10, wherein the non-conductive material comprises a rubber, a polymer, a non-conductive metal, or a wood containing material.

12. The apparatus of claim 1, wherein a distance between the first end and the second end is from about 2 cm to about 30 cm.

13. The apparatus of claim 1, wherein a length of the first plurality of prongs in a direction substantially perpendicular to the first opening interface is from 1 mm to about 8 mm.

14. The apparatus of claim 1, wherein the second end includes a second opening interface which connects to a second hollow recess; and a second plurality of prongs is attached to the second opening interface, wherein at least two of the second plurality of prongs have an inward facing surface a second distance from a second center of the second opening interface.

15. The apparatus of claim 14, wherein the second opening interface comprises a second inner lip and a second outer lip, and
wherein a longest span across the second opening interface of the second inner lip is from about 0.5 mm to 4 mm less than a longest span across the second opening interface of the second outer lip.

16. The apparatus of claim 14, wherein the second plurality of prongs is attached directly to the second outer lip.

17. The apparatus of claim 14, wherein the second distance is from about ⅛ inch to about ½ inch or from about 3 mm to about 15 mm;
wherein the second distance is configured to fit a nut selected from the group consisting of a ¼ inch nut, a 5/16 inch nut, a ⅜ inch nut, a 7/16 inch nut, a ½ inch nut, a 9/16 inch nut, a ⅝ inch nut, a ¾ inch nut, a ⅞ inch nut, and a 1 inch nut; or
wherein the second distance is configured to fit a nut selected from the group consisting a 6 mm nut, a 7 mm nut, a 8 mm nut, a 10 mm nut, a 12 mm nut, a 14 mm nut, a 16 mm nut, a 18 mm nut, and a 20 mm nut; and
wherein the first distance and the second distance are the same or different.

18. The apparatus of claim 14, wherein the first hollow recess and the second hollow recess are connected or unconnected.

19. The apparatus of claim 1, wherein the second opening interface has a shape configured to engage a ratchet, a wrench, or a handle.

20. The apparatus of claim 1, wherein at least one of the first opening interface and the second opening interface is attached to the driving stem by a hinge, or
at least one of the first opening interface and the second opening interface is directly attached to the driving stem.
